(19) United States
(12) Patent Application Publication
(10) Pub. No.: US 2026/0213622 A1
(43) Pub. Date: Jul. 23, 2026

(54) MOTOR UNIT

(71) Applicant: TOYOTA JIDOSHA KABUSHIKI KAISHA, Toyota-shi (JP)

(72) Inventors: Motoki TAKENO, Nisshin-shi (JP); Shuma NAITO, Nisshin-shi (JP)

(73) Assignee: TOYOTA JIDOSHA KABUSHIKI KAISHA, Toyota-shi (JP)

(21) Appl. No.: 19/312,830

(22) Filed: Aug. 28, 2025

(30) Foreign Application Priority Data
Jan. 21, 2025 (JP) 2025-008407

(51) Int. Cl. H02K 11/01; H02K 11/225; H02K 24/00

(52) U.S. Cl. CPC H02K 11/0141; H02K 11/225; H02K 24/00

(57) ABSTRACT

The motor unit includes a motor and a resolver that detects a rotation angle of the motor. The motor includes a stator and a rotor disposed inward of an inner circumferential surface of a stator core and rotatably supported, and the resolver includes a resolver rotor attached to a rotor shaft that is a shaft of the rotor and configured to rotate together with the rotor shaft, and a resolver stator. The motor unit further includes a shielding plate that is made of a magnetic material and is disposed between the rotor and the resolver stator while maintaining a predetermined distance from the resolver stator.

### CROSS-REFERENCE TO RELATED APPLICATION

This application claims priority to Japanese Patent Application No. 2025-008407 filed on Jan. 21, 2025. The disclosure of the above-identified application, including the specification, drawings, and claims, is incorporated by reference herein in its entirety.

### BACKGROUND

### 1. Technical Field

The technique disclosed in the present specification relates to a motor unit including a motor and a resolver configured to detect a rotation angle of the motor.

2. Description of Related Art

A resolver is used as a sensor for detecting a rotation speed (rotation angle) of a motor that is mounted on a vehicle and performs either or both of driving and generating power.

Japanese Unexamined Patent Application Publication No. 2011-217519 (JP 2011-217519 A) discloses an electromagnetic shielding structure for providing shielding from electromagnetic noise generated from a coil end of a stator of a motor. According to JP 2011-217519 A, a shielding plate is disposed between a resolver stator core and the coil end of a coil wound around the stator of the motor. The coil end protrudes in an axial direction from the stator.

### SUMMARY

Due to demands for downsizing the motor unit, downsizing of the coil end has been promoted, and a distance between the resolver and the rotor of the motor has become shorter than a distance between the resolver and the coil end. In consideration of such a situation, a shielding structure in which the shielding plate is disposed between the coil end and the resolver stator core as disclosed in JP 2011-217519 A does not provide sufficient shielding from electromagnetic noise generated from the rotor or a gap between the rotor and the stator.

The present specification discloses
a motor unit including a motor and a resolver configured to detect a rotation angle of the motor.

The motor includes
a stator including a stator core and a coil attached to the stator core, and
a rotor disposed inward of an inner circumferential surface of the stator core and rotatably supported.

The resolver includes
a resolver rotor attached to a rotor shaft that is a shaft of the rotor and configured to rotate together with the rotor shaft, and
a resolver stator including a resolver stator core having an annular shape and disposed to surround an outer circumferential surface of the resolver rotor, and a resolver coil attached to the resolver stator core.

The motor unit further includes a shielding plate that is made of a magnetic material and is disposed between the rotor and the resolver stator while maintaining a predetermined distance from the resolver stator. With the configuration, the shielding plate disposed between the rotor and the

resolver stator can provide shielding from the electromagnetic noise generated from the rotor or the gap between the rotor and the stator, and can suppress erroneous detection of the rotation angle by the resolver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically showing a configuration of a motor unit;

FIG. 2 is an exploded perspective view showing a shielding plate, a resolver stator, and a part of a casing;

FIG. 3 is a partial cross-sectional view showing an example of a state in which the shielding plate and the resolver stator are fixed to the casing by a fastening member;

FIG. 4 is a partial cross-sectional view showing an example different from FIG. 3 of a state in which the shielding plate and the resolver stator are fixed to the casing by the fastening member;

FIG. 5 is a perspective view showing a shielding plate according to an example different from FIG. 2; and

FIG. 6 is a diagram showing a graph for describing the effect of the present embodiment.

### DETAILED DESCRIPTION OF EMBODIMENTS

The main features of the embodiment to be described below will be listed. These features can be combined in any desired manner.

According to the motor unit disclosed in the present specification, the shielding plate may cover the entire range of the resolver stator facing the rotor. With the configuration, since the shielding plate covers the entire range of the resolver stator facing the rotor between the rotor and the resolver stator, the resolver can be accurately protected from electromagnetic noise.

According to the motor unit disclosed in the present specification, the shielding plate and the resolver stator may be fixed to a casing accommodating the motor by a common fastening member.

With the configuration, the shielding plate can be positioned relative to the resolver stator with a simple configuration.

According to the motor unit disclosed in the present specification, the shielding plate may include a shielding side plate disposed between a coil end of the coil that protrudes from the stator core in an axial direction parallel to the rotor shaft and the resolver stator. With the configuration, the shielding side plate can shield the electromagnetic noise generated from the coil end, thereby protecting the resolver.

According to the motor unit disclosed in the present specification, a distance between an end portion of the shielding plate facing the rotor shaft and the rotor shaft may be smaller than a distance between the outer circumferential surface of the resolver rotor and the rotor shaft.

With the configuration, the shielding effect against the electromagnetic noise on the resolver can be enhanced by covering, with the shielding plate, the space between the rotor and the resolver stator as close as possible to the rotor shaft.

An embodiment will be described with reference to the drawings. Each of the drawings is merely an example, and the present embodiment is not limited to the content shown in the drawings. In addition, since each of the drawings is an example, a part of the content may be omitted.

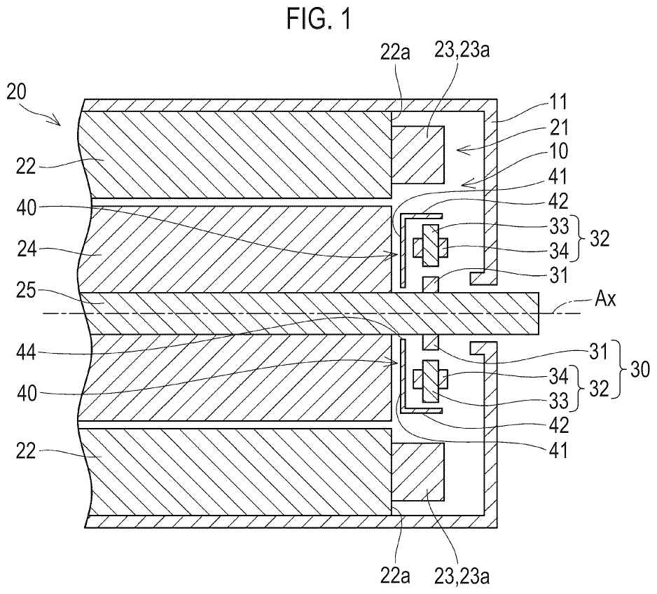

FIG. 1 is a cross-sectional view taken along the center axis Ax of the motor 20, and schematically shows a configuration of a motor unit 10 including a motor 20 and a resolver 30 that detects a rotation angle of the motor 20. The motor unit 10 is accommodated in the casing 11. Note that a part of the configuration of the motor unit 10 may be present outside the casing 11. The motor 20 is driven by receiving the supply of the electric power from the outside. The concept of the motor includes various motors, such as a direct current (DC) motor, an alternating current (AC) motor, a stepping motor, and a servo motor.

The motor 20 includes a stator 21 and a rotor 24. The stator 21 includes a stator core 22 having a cylindrical shape fixed in the casing 11 and a coil 23 attached to the stator core 22. Hereinafter, a radial direction of the motor 20, a circumferential direction of the motor 20, and an axial direction of the motor 20 are simply referred to as a radial direction, a circumferential direction, and an axial direction, respectively. The axial direction is a direction parallel to the center axis Ax. The radial direction is a direction that intersects the center axis Ax perpendicularly and extends radially from the center axis Ax. In the radial direction, a side closer to the center axis Ax is radially inward, and a side farther from the center axis Ax is radially outward. In the present embodiment, the cylindrical shape or the annular shape may refer to a shape that is a circular shape in a cross-section perpendicular to the axial direction, as well as a shape that is close to a polygonal shape.

The coil 23 is made by winding a coil wire serving as a conductor around the stator core 22. In the present embodiment, a method of attaching the coil 23 to the stator core 22 or a method of winding the coil 23 around the stator core 22 is not particularly limited. The coil 23 is wound around the stator core 22 and extends along the circumferential direction. A first end surface 22a refers to one of the end surfaces of the stator core 22 facing the axial direction. In FIG. 1, the other of the end surfaces (second end surface) of the stator core 22 facing the axial direction is omitted. A part of the coil 23 protrudes from each of the first end surface 22a and the second end surface in the axial direction. A part of the coil 23 that protrudes from each of the first end surface 22a and the second end surface is referred to as a coil end 23a. In FIG. 1, since the coil 23 is shown in a very simplified manner, solely the coil end 23a of the coil 23 is shown as a result.

The rotor 24 is disposed radially inward of the inner circumferential surface of the stator core 22 and is rotatably supported. The rotor 24 is rotatably supported about the center axis Ax, for example, by a bearing (not shown) fixed to the casing 11. The stator 21 and the rotor 24 are concentrically disposed with reference to the center axis Ax. A shaft of the rotor 24 is referred to as a rotor shaft 25. The rotor shaft 25 extends further than the rotor 24 in the axial direction. When the electric power is supplied to the coil 23, the rotor 24 including the rotor shaft 25 is rotated by the action of the magnetic field. The rotation of the rotor shaft 25 is transmitted, for example, to a shaft of a wheel through a power transmission mechanism (not shown).

In order to control the rotation speed or the torque of the wheel, there is a demand for detecting the rotation angle of the rotor shaft 25 with high accuracy. The resolver 30 is a sensor for detecting a rotation angle of the rotor shaft 25. The resolver 30 includes a resolver rotor 31 and a resolver stator 32. The resolver rotor 31 is attached to the rotor shaft 25 and is configured to rotate together with the rotor shaft 25. Specifically, the resolver rotor 31 has an annular shape and is fixed to the rotor shaft 25 in a state where the rotor shaft 25 is inserted through the inner side of the resolver rotor 31.

The resolver stator 32 includes a resolver stator core 33 and a resolver coil 34 attached to the resolver stator core 33. The resolver stator core 33 has an annular shape. The resolver stator core 33 is disposed to surround the outer circumferential surface of the resolver rotor 31. That is, the resolver stator 32 and the resolver rotor 31 are concentrically disposed with reference to the center axis Ax. The resolver coil 34 is wound around the resolver stator core 33 in a manner substantially similar to the relationship between the stator core 22 and the coil 23. In the present embodiment, the function, the operation, and the usage method of the resolver 30 will be appropriately referred to a general description, and the description thereof will be omitted.

The motor unit 10 includes a shielding plate 40 that is made of a magnetic material and is disposed between the rotor 24 and the resolver stator 32 while maintaining a predetermined distance from the resolver stator 32. The magnetic material is, for example, iron. The magnetic material may be, for example, nickel or cobalt. The shielding plate 40 is disposed not to contact the resolver stator 32. According to FIG. 1, the shielding plate 40 is positioned between the rotor 24 and the resolver stator 32 in the axial direction. With such a configuration, the shielding plate 40 can shield the electromagnetic noise generated from the rotor 24 or the gap between the rotor 24 and the stator 21, and can suppress the erroneous detection of the rotation angle by the resolver 30 caused by the electromagnetic noise. The present embodiment is particularly useful in a situation where, due to demands for downsizing the motor unit 10, the distance between the resolver 30 and the rotor 24 has become shorter.

As shown in FIG. 1, the shielding plate 40 covers the entire range of the resolver stator 32 facing the rotor 24, that is, the entire range of the resolver stator 32 facing the rotor 24 in the axial direction. With such a configuration, the shielding plate 40 can accurately protect the resolver 30 from the electromagnetic noise generated from the rotor 24. Note that, as a modification, a configuration in which a part of the range of the resolver stator 32 facing the rotor 24 is not covered by the shielding plate 40 is also conceivable.

According to FIG. 1, a cross-section of the shielding plate 40 has a substantially L-shape, and the shielding plate 40 has a shape that covers at least a part of a surface of the resolver stator 32 facing the coil end 23a in the radial direction. That is, the shielding plate 40 includes a shielding side plate 42 disposed between the resolver stator 32 and the coil end 23a that protrudes from the stator core 22 in the axial direction. The shielding side plate 42 can shield the electromagnetic noise generated from the coil end 23a, thereby protecting the resolver 30. In the shielding plate 40 including the shielding side plate 42, a surface facing the rotor 24 is referred to as a rotor-facing plate 41 for convenience. That is, the “shielding plate 40 that is disposed between the rotor 24 and the resolver stator 32 while maintaining a predetermined distance from the resolver stator 32” substantially refers to the rotor-facing plate 41.

According to FIG. 1, a distance (radial distance) between an end portion 44 of the shielding plate 40 (rotor-facing plate 41) facing the rotor shaft 25 and the rotor shaft 25 is smaller than a distance (radial distance) between an outer circumferential surface of the resolver rotor 31 (a surface facing the resolver stator core 33) attached to the rotor shaft 25 and the rotor shaft 25. That is, the shielding plate 40 covers the space between the rotor 24 and the resolver stator 32 as close as possible to the rotor shaft 25. As a result, it is possible to further enhance the shielding effect against the electromagnetic noise on the resolver 30.

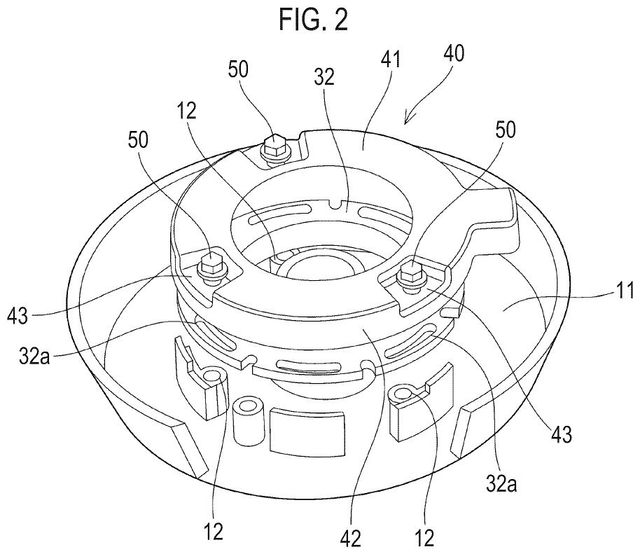

FIG. 2 is an exploded perspective view showing a shielding plate 40, a resolver stator 32, and a part of the casing 11. The shielding plate 40 has a substantially annular shape to cover the resolver stator 32 in correspondence with the resolver stator 32 having an annular shape. The shielding plate 40 shown in FIG. 2 includes a rotor-facing plate 41 and a shielding side plate 42. Although omitted in FIG. 2, it can be seen from FIG. 2 that the rotor 24 is disposed above the rotor-facing plate 41, and the rotor shaft 25 and the resolver rotor 31 are positioned radially inward relative to the resolver stator 32.

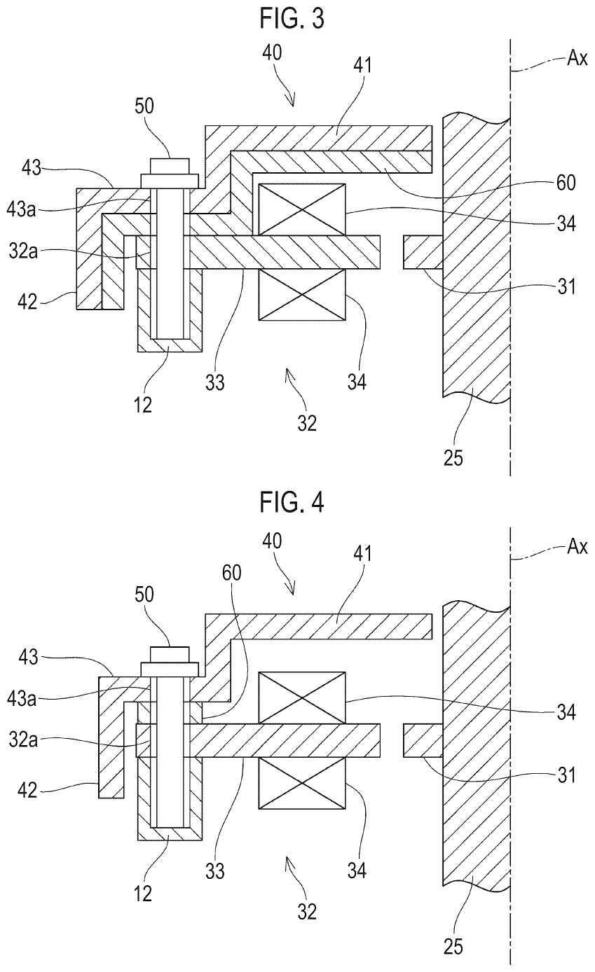

The shielding plate 40 only needs to be fixed by some fixing means in the casing 11, disposed as described above without contacting the resolver stator 32. As an example, the shielding plate 40 and the resolver stator 32 are fixed to the casing 11 by a common fastening member. The bolt 50 shown in FIG. 2 corresponds to an example of the fastening member. According to FIG. 2, a plurality of recesses 43 that are recessed toward the side of the resolver stator 32 in the axial direction are provided at regular intervals along the circumferential direction on the rotor-facing plate 41 of the shielding plate 40. Each of the recesses 43 has a hole 43a (see FIGS. 3 and 4) provided therethrough in the axial direction for inserting the bolt 50. In addition, the resolver stator 32 also has a plurality of holes 32a provided therethrough in the axial direction for inserting the bolt 50. Further, in the casing 11, a boss 12 for inserting and screwing the bolt 50 is erected in the axial direction. Therefore, the common bolt 50 is inserted through the hole 43a, the hole 32a, and the boss 12 that are aligned with each other from the rotor-facing plate 41 side, and the bolt 50 is screwed into the boss 12. As a result, the shielding plate 40 and the resolver stator 32 are fixed to the casing 11.

The motor unit 10 may include an intermediate member 60 made of a non-magnetic material that is interposed between the shielding plate 40 and the resolver stator 32 to maintain the shielding plate 40 at a position spaced from the resolver stator 32 by a predetermined distance. The non-magnetic material is a particularly metal material that cannot be magnetized, and is, for example, aluminum or stainless steel. The shielding plate 40, made of a magnetic material, is disposed between the rotor 24 and the resolver stator 32 while maintaining a predetermined distance from the resolver stator 32 by the non-magnetic material intermediate member 60. As a result, the shielding plate 40 and the resolver stator 32 are magnetically disconnected, the shielding plate 40 can accurately shield the electromagnetic noise generated from the rotor 24 or the gap between the rotor 24 and the stator 21, and can suppress the erroneous detection of the rotation angle by the resolver 30.

FIG. 3 is a partial cross-sectional view schematically showing an example of a state in which the shielding plate 40 and the resolver stator 32 are fixed to the casing 11 by the fastening member. In FIGS. 3 and 4, solely the boss 12 is shown as the casing 11, and the other components are omitted. In FIG. 3, the shielding plate 40 and the intermediate member 60 are clad materials that are provided in advance by joining the shielding plate 40 and the intermediate member 60 to each other. That is, by integrally molding the clad material in which the layer of the magnetic material and the layer of the non-magnetic material are joined to each other, the member made of the shielding plate 40 and the intermediate member 60 having the shape as shown in FIGS. 2 and 3 is realized. According to FIG. 3, the intermediate member 60 extends over the entire surface of the shielding plate 40 facing the side of the resolver stator 32, and the distance between the shielding plate 40 and the resolver stator 32 is maintained constant by the thickness of the intermediate member 60. That is, the intermediate member 60 is sandwiched between the shielding plate 40 and the resolver stator 32. According to FIG. 3, the intermediate member 60 is in contact with the resolver stator core 33. The intermediate member 60 may be in contact with the resolver coil 34 or may not be in contact with the resolver coil 34.

According to FIG. 3, the hole 43a penetrates the shielding plate 40 and the intermediate member 60. In addition, the hole 32a penetrates the resolver stator core 33 of the resolver stator 32. Therefore, the common bolt 50 is inserted through the hole 43a, the hole 32a, and the boss 12 that are aligned with each other, and the bolt 50 is screwed into the boss 12. As a result, the shielding plate 40, the intermediate member 60, and the resolver stator 32 are fixed to the casing 11. As described above, by using the clad material, it is possible to easily and reliably hold the shielding plate 40 at a position spaced from the resolver stator 32 by a predetermined distance. Although omitted from the drawings, it can be understood that the bolt 50, the holes 43a, 32a, and the boss 12 are screwed together by respective screw threads and screw grooves provided on each of the bolt 50, the holes 43a, 32a, and the boss 12.

FIG. 4 is a partial cross-sectional view schematically showing an example, different from FIG. 3, of a state in which the shielding plate 40 and the resolver stator 32 are fixed to the casing 11 by the fastening member. The points different from FIG. 3 will be described in FIG. 4. In FIG. 4, the shielding plate 40 is not the clad material. According to

FIG. 4, the intermediate member 60 is a washer made of a non-magnetic material that allows the bolt 50 to be inserted. That is, the common bolt 50 is inserted through the hole 43a, the annular washer (intermediate member 60), the hole 32a, and the boss 12 that are aligned with each other, and the bolt 50 is screwed into the boss 12. As a result, the shielding plate 40, the intermediate member 60, and the resolver stator 32 are fixed to the casing 11. By using the washer, it is possible to hold the shielding plate 40 at a position spaced from the resolver stator 32 by a predetermined distance at a low cost.

The hole 43a is provided in the shielding plate 40. The hole 43a may allow the electromagnetic noise to pass through, potentially reducing the shielding effect of the shielding plate 40. In such a situation, the bolt 50 is made of a magnetic material, such as iron, similarly to the shielding plate 40, and the bolt 50 is inserted into the hole 43a. As a result, the hole 43a is closed off by the head of the bolt 50, and the shielding effect of the shielding plate 40 is maintained.

The disclosure of the present embodiment may also include a configuration in which the distance between the shielding plate 40 and the resolver stator 32 is maintained by a member, such as a spacer, other than the intermediate member 60 made of a non-magnetic material. The spacer is, for example, a member made of resin. Note that, in consideration of firmly and stably fixing the shielding plate 40 by tightening the bolt 50, the intermediate member 60 as described above is preferable to a spacer made of resin.

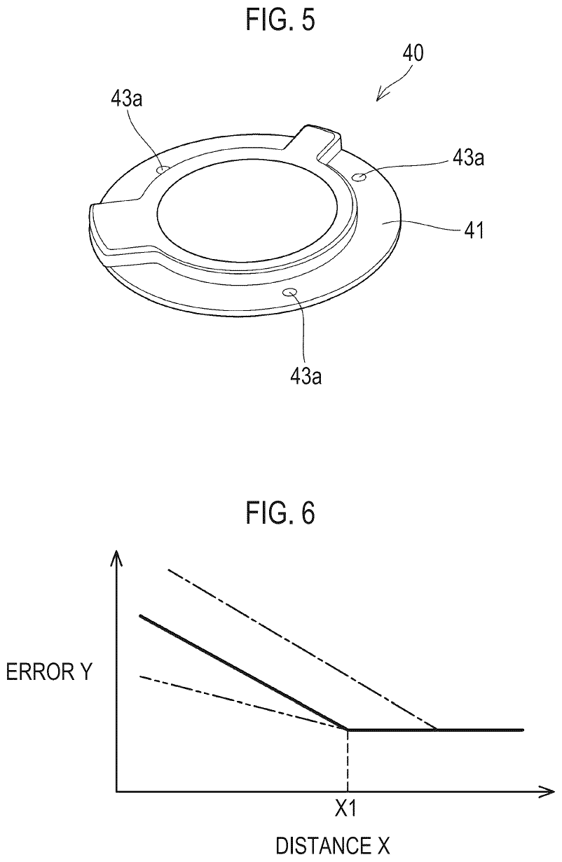

FIG. 5 is a perspective view showing the shielding plate 40 according to an example from the same viewpoint as in FIG. 2. The shielding plate 40 shown in FIG. 5 has basically the same features as the shielding plate 40 described with reference to FIGS. 1 to 4. According to FIG. 5, the shielding plate 40 includes the rotor-facing plate 41, and a plurality of holes 43a are provided at regular intervals along the circumferential direction on the rotor-facing plate 41. Note that the shielding plate 40 shown in FIG. 5 does not include the shielding side plate 42. That is, the shielding plate 40 may have a configuration without the shielding side plate 42.

FIG. 6 is a graph showing the effect of the present embodiment. The graph in FIG. 6 shows a magnitude of a detection error (error Y) of a rotation angle by the resolver 30 corresponding to a distance X from the rotor 24 to the resolver stator 32 in the axial direction. In FIG. 6, a solid line indicates an error Y in a case without the shielding plate 40 of the present embodiment, and a two-dot chain line indicates an error Y in a case with the shielding plate 40 of the present embodiment. In FIG. 6, a one-dot chain line indicates an error Y when the shielding plate 40 is in contact with the resolver stator 32. According to FIG. 6, when the shielding plate 40 made of a magnetic material contacts the resolver stator 32, the shielding effect against the electromagnetic noise significantly decreases, resulting in an increase in error Y compared to the case without the shielding plate 40. According to FIG. 6, in a case where the distance X is equal to or less than a predetermined value X1, the error Y without the shielding plate 40 is greater than the error Y with the shielding plate 40. In addition, the difference between the error Y in a case without the shielding plate 40 and the error Y in a case with the shielding plate 40 is larger as the distance X equal to or less than the predetermined value X1 is smaller. From FIG. 6 as well, it can be said that the present embodiment exhibits an excellent effect in a situation where, due to the demands for downsizing of the motor unit 10, the distance between the resolver 30 and the rotor 24 has become shorter.

Although specific examples of the technique disclosed in the present specification have been described in detail above, these examples are merely illustrative and do not limit the scope of the claims. The technique described in the claims includes various modifications and changes of the specific examples illustrated above. In addition, the technical elements described in the present specification or the drawings exhibit technical usefulness alone or in various combinations and are not limited to the combinations described in the claims at the time of filing. Further, the technique exemplified in the present specification or the drawings achieves a plurality of objectives at the same time, and achieving one of the objectives has technical usefulness.

What is claimed is:

1. A motor unit comprising:
a motor; and
a resolver configured to detect a rotation angle of the motor, wherein:
the motor includes
a stator including a stator core and a coil attached to the stator core, and
a rotor disposed inward of an inner circumferential surface of the stator core and rotatably supported;
the resolver includes
a resolver rotor attached to a rotor shaft that is a shaft of the rotor and configured to rotate together with the rotor shaft, and
a resolver stator including a resolver stator core having an annular shape and disposed to surround an outer circumferential surface of the resolver rotor, and a resolver coil attached to the resolver stator core; and
the motor unit further includes a shielding plate that is made of a magnetic material and is disposed between the rotor and the resolver stator while maintaining a predetermined distance from the resolver stator.

2. The motor unit according to claim 1, wherein the shielding plate covers an entire range of the resolver stator, the entire range facing the rotor.

3. The motor unit according to claim 1, wherein the shielding plate and the resolver stator are fixed to a casing accommodating the motor by a common fastening member.

4. The motor unit according to claim 1, wherein the shielding plate includes a shielding side plate disposed between a coil end of the coil and the resolver stator, the coil end protruding from the stator core in an axial direction parallel to the rotor shaft.

5. The motor unit according to claim 1, wherein a distance between an end portion of the shielding plate, the end portion facing the rotor shaft, and the rotor shaft is smaller than a distance between the outer circumferential surface of the resolver rotor and the rotor shaft.
